(19) United States
(12) Patent Application Publication
(10) Pub. No.: US 2007/0248780 A1
(43) Pub. Date: Oct. 25, 2007

(54) FIBROUS LAMINATE AND METHOD FOR THE PRODUCTION THEREOF

(75) Inventors: Michael Schober, Muenchen (DE); Reinhold Schoenacher, Adelzhausen (DE); Siegfried Sikorski, Muenchen (DE)

Correspondence Address: DAVIDSON, DAVIDSON & KAPPEL, LLC, 485 SEVENTH AVENUE, 14TH FLOOR, NEW YORK, NY, 10018, US

(73) Assignee: MTU Aero Engines Gmbh, Muenchen (DE)

(21) Appl. No.: 10/566,317

(22) PCT Filed: Jul. 22, 2004
(86) PCT No.: PCT/DE04/01636

§ 371 Date: Feb. 26, 2007

(30) Foreign Application Priority Data
Jul. 29, 2003 (DE) 103 34 342.3

(51) Int. Cl. B29C 70/54

(52) U.S. Cl. 428/57; 264/258; 28/107

(57) ABSTRACT

A fiber laminate is provided, as well as a method for producing the fiber laminate and a method for making a component from the fiber laminate. The fiber laminate includes several fiber layers having reinforcement fibers extending in a preferential direction, and/or several multiaxial nonwoven fabrics consisting of reinforcement fibers, of various contours, wherein the fiber layers are fixed one under the other and/or placed in the multiaxial nonwoven one on top of the other along at least one area before contouring.

The invention relates to a process for producing a fibrous laminate comprising several fibrous layers with reinforcing fibers extending in each instance in a preferential direction and/or comprising several multiaxial laminates consisting of reinforcing fibers of differing contour, and also to fibrous laminates of such a type and to a process for producing a construction element for turbo-machines, in particular for gas turbines.

Composite construction elements in which reinforcing fibers of the most diverse materials are embedded in a matrix are commonly employed nowadays where the properties of high tensile strength drive out steel and other materials. In order in this connection to produce construction elements, on the one hand there is the possibility of interweaving fibers in braiding machines in such a manner that the fibrous braided fabric exhibits the desired fiber flow and corresponds to the shape of the construction element to be formed. On the other hand, with less effort it is also possible to build up the construction element in layers from individual fibrous layers in which the reinforcing fibers extend in a preferential direction and to create, with differing orientations of the fiber alignment in the various layers, a fiber blank that is adapted to the construction element and that exhibits the desired properties. In this regard the various layers or, to be more exact, fibrous layers exhibit a differing contour, corresponding to the section through the construction element.

For the purpose of simplifying production, it is also possible for the fibrous layers with reinforcing fibers extending in a preferential direction to be replaced—partially or entirely—by multiaxial laminates in which several directions of orientation of the reinforcing fibers are realized in one layer.

With this process, according to the state of the art the individual fibrous layers or multiaxial laminates are cut to size with templates in accordance with their position in the construction element and in accordance with their corresponding size or outline, or are punched out using stamping tools. After this, the individual, cut-to-size layers (fibrous layers or multiaxial laminates) are laid down in the appropriate sequence and are positioned before the laminate is infiltrated with the matrix in a mould.

With a process that is operated in such a manner there is a disadvantageous effect, inasmuch as the cut-to-size layers have to be laid down and positioned individually in the apparatus or mould in the correct sequence. This involves a considerable expenditure of time. In addition, inaccuracies in the course of laying and positioning can only be avoided by taking special care. Should the low tolerances not be complied with here, the construction elements manufactured in this way cannot be used.

The object of the invention is to specify a process for producing a fibrous laminate from several fibrous layers with reinforcing fibers extending in each instance in a preferential direction and/or from several multiaxial laminates consisting of reinforcing fibers of differing contour, which process requires little expenditure of time and with which process the prescribed tolerances can be better complied with. In addition, a process for producing a construction element from fibrous laminates of such a type, which is as simple, economic and tolerance-free as possible, and also a fibrous laminate consisting of several fibrous layers with reinforcing fibers extending in each instance in a preferential direction and/or of several multiaxial laminates consisting of reinforcing fibers of differing contour, which can be processed as simply as possible, are to be specified.

The object relating to the process for producing the fibrous laminate of the type described in the introduction is characterized, according to the invention, in that the fibrous layers and/or multiaxial laminates are fixed, one below the other, superimposed along at least one region, and are subsequently contoured.

Consequently, with the process according to the invention firstly a stack of the requisite number of fibrous laminates and/or multiaxial laminates is made available. But before a contouring of the individual layers (fibrous layer or multiaxial laminate) takes place all the layers are fixed, one below the other, along one region, so that they can no longer be displaced relative to one another. Subsequently the contouring of the individual layers is then carried out, by the individual layers being “leafed through” for this purpose. The deformability of the fibrous laminate produced in this way is preserved, so construction elements having complex contours and surfaces can also be produced.

With the process according to the invention, the precise positioning of the individual cut-to-size layers is dispensed with, by virtue of which considerable costs can be saved. In addition, the quality of the construction elements rises, since the positioning of the individual layers relative to one another becomes more precise, inasmuch as the precision corresponds to that of the stamping tools which can be produced with a much narrower tolerance.

For the purpose of fixing, the individual layers can be connected in pointwise manner within a certain region, but this is preferably done along a line. This is technically easy to effect; in addition, the easy accessibility of each individual layer is thereby guaranteed.

It is expedient if glass fibers, carbon fibers or aramide fibers are employed by way of reinforcing fibers pertaining to the fibrous layers or multiaxial laminates. This offers a broad range of possible applications by optimal adaptation of the reinforcing fibers to the respective requirements.

The fixing of the layers one below the other is preferably realized by fiber technology, particularly preferably by stitching of the layers or by tufting of the layers among themselves. This is easy, cost-effective and sufficient for a lasting fixing of the layers for further processing. In addition, the fibriform structure of the fibrous layers or multiaxial laminates accommodates this processing step, since by reason of their structure the layers can be connected with threads of the same material.

Alternatively it may be advantageous to connect or to fix the layers one below the other mechanically, in a particularly advantageous manner by clipping or by adhesion bonding. These connection methods are an advantage when a point-wise or planar region for the fixing is chosen.

After the fixing of the layers one below the other, the individual layers are brought into shape—that is to say, contoured. For this purpose, the layers that are not being machined are preferably protected during the machining of the layer to be contoured, this preferably being done, in particular, by the fibrous layers or multiaxial laminates to be protected being mechanically protected, for example by means of a metal sheet, or by the layers that are not to be machined being folded away along the fixing. As a result of the fixing, the individual layers can be contoured in any sequence without the position of the individual layers in relation to one another being changed. In this way the desired contour of the respective layer can be adjusted in accordance with the set values. This is also guaranteed in the case of complex contours and in the case of fibrous laminates to be deformed later. In this connection the tolerance of the fibrous laminate produced that is attained corresponds to the tolerance of the tools for the purpose of contouring, which can be produced—and which work—with very narrow tolerances.

The most varied methods may be employed for the purpose of contouring the individual layers, but the layers are preferably cut with knives or shears, punched or detached from the original layer by laser.

The solution to the object relating to the process for producing a construction element for turbo-machines, in particular for gas turbines, in particular for turbine blades, is characterized, according to the invention, in that several fibrous layers with reinforcing fibers extending in each instance in a preferential direction and/or several multiaxial laminates consisting of reinforcing fibers are superimposed, the fibrous layers and/or multiaxial laminates are fixed, one below the other, along at least one region, individual fibrous layers and/or multiaxial laminates are contoured in such a manner that the shape of the fibrous laminate corresponds to the shape of the construction element, the fibrous laminate is introduced into a mould having a cavity that is complementary to the contour of the construction element, the cavity is filled by impregnating the fibrous laminate with a fluid matrix, and the matrix is solidified.

In this connection the laminated structure and the contouring are chosen in such a way that the geometry of the fibrous laminate corresponds, flat or curved, to the shape of the construction element—for example, a stator blade or moving blade with or without shroud band or a casing part—and the desired ratio of fibrous constituent to cavity—i.e. matrix—arises.

As a result of the fixing of the individual superimposed layers (fibrous layers or multiaxial laminates), it may happen that an unintentional fiber direction perpendicular to the layers arises or that, as a result of a mechanical fixing (e.g. gluing), defects are introduced into the construction element to be produced. Consequently it is an advantage if the region of fixing is laid down outside the mould in the course of producing the construction element. This has the result that this region is not jointly processed in the construction element, so that it can be detached after the solidification of the matrix. The construction element then contains only the laminated structure that was desired as a result of the stacking of the individual fibrous layers or multiaxial laminates.

The solidification of the flowable matrix which has been introduced is advantageously carried out by means of a chemical or physical reaction. By this means the hardening can be controlled precisely, by virtue of which it is ensured that the entire cavity between the reinforcing fibers is filled out with a matrix and no voids are introduced.

For the matrix use is preferably made of curable synthetic resins, in particular epoxy resins, bismaleimides or polyimides. In interaction with the materials for the reinforcing fibers (glass fibers, carbon fibers or aramide fibers), construction elements having high tensile strength and breaking strength are produced by this means.

The solution to the object with regard to the fibrous laminate is characterized, according to the invention, in that fibrous layers and/or multiaxial laminates are fixed along a line, superimposed on one another.

As a result of the fixing of the individual superimposed fibrous layers and/or multiaxial laminates along a line, the fibrous laminate with the variably contoured layers is easy to handle during further processing (for example, placing into a mould). As a result of the fixing, the individual layers no longer change their position relative to one another during further processing, so slippage can be ruled out.

By this means, a subsequent positioning of the individual layers is dispensed with, by virtue of which costs can be saved. In addition, as a result of the fixing of the layers, one below the other, the quality of the construction elements to be produced rises, because the positioning of the individual layers relative to one another is more precise. The deformability of the fibrous laminate is also preserved as a result of the fixing, so that construction elements having complex contours and geometries can also be produced from fibrous laminates of such a type.

The reinforcing fibers of the fibrous layers or of the multiaxial laminates are preferably glass fibers and/or carbon fibers and/or aramide fibers.

The fibrous layers and/or multiaxial laminates are advantageously fixed, one below the other, by sewing, tufting, clipping or adhesive bonding. These are techniques which are easy to manage; in addition, these fixings have the least influence on the laminated structure and the strength properties of the structure.

The invention will be described in more detail in the following on the basis of exemplary embodiments represented in drawings, from which further particulars, features and merits will become clear.

Shown are:

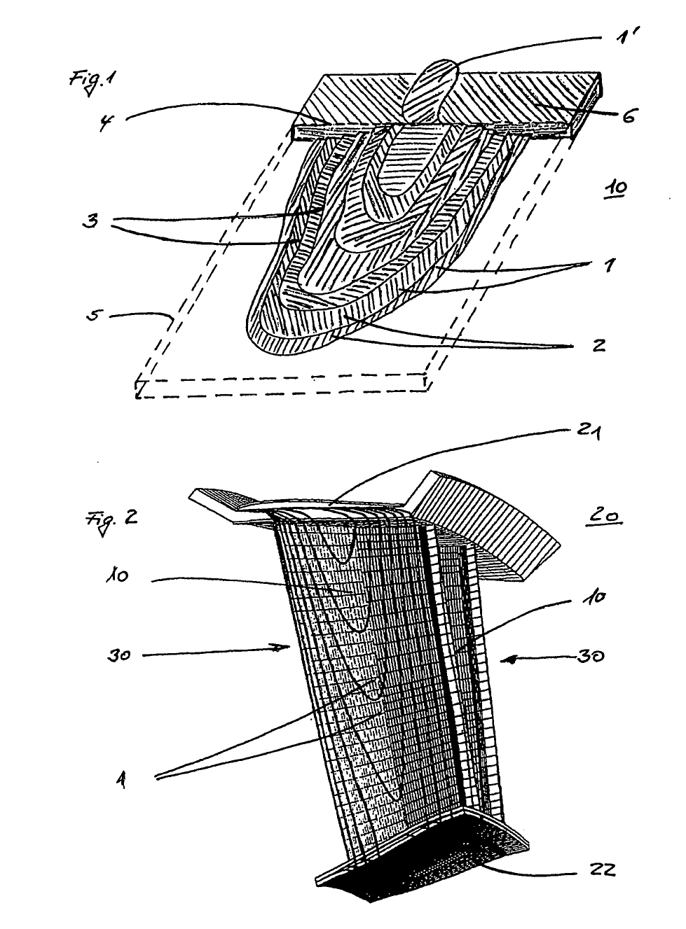

FIG. 1 a fibrous laminate 10 which consists of several superimposed fibrous layers 1 and which was produced in accordance with the process according to the invention;

FIG. 2 a construction element 20 of a turbo-machine, in particular of a gas turbine, which was produced from two fibrous laminates 10 by the process according to the invention.

In the case of the fibrous laminate 10 shown in FIG. 1, use was made exclusively of fibrous layers 1 for the purpose of production. However, in addition to the fibrous layers 1 it is also possible to use multiaxial laminates. The fibrous layers 1 used here comprise glass fibers by way of reinforcing fibers 2, which for each fibrous layer 1 extend in a respective preferred direction. The alignment of the reinforcing fibers 2 is influenced by the forces on the fibrous laminate 10 that arise later in operation.

The individual fibrous layers 1 have been modified in their contour 3 in such a manner that the entire fibrous laminate 10 exhibits the desired geometry which is required for the subsequent construction element. The individual fibrous layers 1 are connected, one below the other, via a seam 4 along a line.

For the purpose of producing the fibrous laminate 10, the requisite number of fibrous layers 1 with the respective alignment of the reinforcing fibers 2 are superimposed, without paying attention to the ultimate contour of the fibrous laminate 10. In the present case the stack of fibrous layers 1 constitutes, prior to the machining of the contour, an outer overall contour which is indicated by the dashed lines 5.

Now, however, instead of lifting the individual fibrous layers I off and machining them, separated from the other fibrous layers, all of the fibrous layers 1 are fixed, one below the other, by means of a seam 4 along a line, so that they have no latitude for movement relative to one another. Subsequent to this fixing, the individual fibrous layers 1′ are subjected to a machining for the purpose of attaining their contour. To this end, the respective fibrous layer 1 to be machined is lifted off from the others (as in the case of fibrous layer 1′, indicated) and is brought to the definitive contour in a stamping tool. The other fibrous layers 1 to be machined are meanwhile folded away for the purpose of protection. All the fibrous layers 1 are dealt with in this way until the entire fibrous laminate 10 exhibits the desired contour. To this end, the stamping tool exhibits several nested templates which are able to machine the individual fibrous layers 1 with a very low tolerance. Since, as a result of the fixing along the seam 4, the fibrous layers 1 can no longer be moved relative to one another, the low tolerance is transferred to the fibrous laminate 10.

FIG. 2 shows, by way of construction element of a turbo-machine, a stator-blade segment 20 with two stator blades 30 of fiber-composite construction and with an inner shroud band 22 and an outer shroud band 21 which are each connected to the stator blades 30 by material closure. The entire stator blade of a low-pressure compressor is composed of segments 20 of such a type so as to form a whole.

Each of the two stator blades 30 is manufactured from a fibrous laminate 10 corresponding to FIG. 1. The production of the stator-blade segment 20 in accordance with the process according to the invention proceeds as follows:

A fibrous laminate 10 is produced from several superimposed fibrous layers 1 in accordance with the process described above, the contour of the fibrous laminate corresponding substantially to the contour of a stator blade 30. These fibrous laminates 10 which are still fixed to the seam 4 are then placed together into a mould exhibiting two cavities that are complementary to the contour of the stator blade 30. The cavities are bounded at the sides by walls, and at the inner and outer end faces by laminates which in the finished state constitute the shroud bands 21, 22.

The region 6 of fixing which is still present in the original fibrous laminate 10 is drawn through a slot-type opening in the shroud bands, in order to achieve a materially closed and positive connection between the individual components in the finished state. However, it is also possible to lay down the region 6 outside the mould and consequently not to fill it with matrix, so that it can be separated after the hardening of the matrix, with the result that the seam 4 is not introduced into the construction element 20.

Subsequently the porosity of the cavity which is filled with the fibrous laminate 10 is evacuated and filled with an epoxy resin by way of matrix, in order to form the stator-blade segment. After the epoxy resin has hardened, the finished construction element can be removed.

In the present examples the fibrous laminates 10 were built up from the individual fibrous layers 1. However, it is also possible to replace individual fibrous layers, or all of them, by multiaxial laminates which combine in themselves several fiber directions in respect of reinforcing fibers. In addition, some of the matrix that is needed later may also already be located in the fibrous layers or multiaxial laminates, by virtue of which the latter are then present in the form of prepregs.

1-18. (canceled)

19. A process for producing a fibrous laminate comprising,
providing (i) a plurality of fibrous layers, each fibrous layer including reinforcing fibers extending in a preferred direction, and/or (ii) a plurality of multiaxial laminates consisting of reinforcing fibers;
fixing the fibrous layers and/or multiaxial laminates, one below the other, superimposed along at least one region, and
thereafter, contouring the resultant fixed fibrous layers and/or multiaxial laminates.

20. The process according to claim 19, wherein the at least one region forms a a line.

21. The process according to claim 19, wherein the reinforcing fibers are selected from the group consisting of glass fibers, carbon fibers, aramide fibers, and combinations thereof.

22. The process according to claim 19, wherein the fixing is performed via fiber technology.

23. The process according to claim 22, wherein the fiber technology is sewing or tufting.

24. The process according to claim 19, wherein the fixing step further comprises mechanical fixing.

25. The process according to claim 24, wherein the mechanical fixing is effected by clipping or adhesive bonding.

26. The process according to claim 19, wherein the contouring step further comprises protecting, during contouring, all the fibrous layers and multiaxial layers that are not currently undergoing contouring.

27. The process according to claim 19, wherein the contouring step further comprises separately contouring at least some of the fibrous layers and/or multiaxial layers, and, during each contouring operation, protecting all the fibrous layers and/or multiaxial layers that are not undergoing contouring during said contouring operation.

28. The process according to claim 26, wherein the fibrous layer(s) to be protected or the multiaxial laminate(s) to be protected are shielded mechanically.

29. The process according to claim 28, wherein the fibrous layer(s) to be protected and/or the multiaxial laminate(s) to be protected are shielded mechanically by a metal sheet.

30. The process according to claim 28, wherein the fibrous layer(s) and/or the multiaxial laminate(s) to be protected are shielded mechanically by folding away the fibrous layer(s) and/or multiaxial laminate(s) to be protected.

31. The process according to claim 19, wherein a contour of the fibrous layers and/or multiaxial laminates is produced during the contouring step by cutting, punching or lasering.

32. A process for producing a construction element for turbo-machines, comprising the steps of:
superimposing (i) a plurality of fibrous layers, each fibrous layer including reinforcing fibers extending in a preferred direction, and/or (ii) several multiaxial laminates consisting of reinforcing fibers;
fixing the fibrous layers and/or multiaxial laminates, one below the other, along at least one region to form a fibrous laminate,
contouring the individual fibrous layers and/or multiaxial laminates of the fibrous laminate such that the shape of the fibrous laminate corresponds to a shape of a construction element to be produced,
introducing the fibrous laminate into a mould having a cavity that is complementary to the shape of the construction element to be produced,
filling the cavity by impregnating the fibrous laminate with a flowable matrix, and
solidifying the matrix to form the construction element from the impregnated fibrous laminate.

33. The process according to claim 32, wherein the at least one region remains outside the mould during the introducing, filling, and solidifying steps.

34. The process according to claim 32, wherein the matrix is solidified by a chemical or physical reaction.

35. The process according to claim 32, wherein the flowable matrix is a curable synthetic resin.

36. The process according to claim 35, wherein the curable synthetic resin is selected from the group consisting of epoxy resins, bismaleimides, and polyimides.

37. A fibrous laminate comprising:
a plurality of fibrous layers of differing contour, each fibrous layer including reinforcing fibers extending in a preferred direction; and/or
a plurality of multiaxial laminates of differing contour, consisting of reinforcing fibers,
wherein the fibrous layers and/or multiaxial laminates are superimposed and fixed, one below the other, along a line.

38. The fibrous laminate according to claim 37, wherein the reinforcing fibers are selected from the group consisting of glass fibers, carbon fibers, aramide fibers, and combinations thereof.

39. The fibrous laminate according to claim 37, wherein the fibrous layers and/or multiaxial laminates are fixed by sewing, tufting, clipping or adhesive bonding.
